(19) United States
(12) Patent Application Publication
(10) Pub. No.: US 2005/0071702 A1
(43) Pub. Date: Mar. 31, 2005

(54) Information processing apparatus and power saving control method

(75) Inventor: Toshikazu Morisawa, Tokorozawa-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/946,338

(22) Filed: Sep. 22, 2004

(30) Foreign Application Priority Data
Sep. 25, 2003 (JP) 2003-334180

(51) Int. Cl. G06F 1/32

(52) U.S. Cl. 713/320

(57) ABSTRACT

An information processing apparatus includes an input device, and a display unit. The information processing apparatus further includes a detection unit configured to detect whether a system state of the information processing apparatus is an idle state or a non-idle state, by monitoring an operation state of the input device, and a control unit configured to decrease a display luminance of the display unit and cause the display unit to display a predetermined image when the detection unit detects the idle state, and configured to restore the display unit to a display state immediately prior to the detection of the idle state when the detection unit detects the non-idle state.

### CROSS-REFERENCE TO RELATED APPLICATIONS

This application is based upon and claims the benefit of priority from prior Japanese Patent Application No. 2003-334180, filed Sep. 25, 2003, the entire contents of which are incorporated herein by reference.

### BACKGROUND OF THE INVENTION

1. Field of the Invention

The present invention relates to an information processing apparatus, such as a personal computer, which can be battery-powered, and a power saving control method that is adopted in the information processing apparatus.

2. Description of the Related Art

A screen saver is known as software for preventing burn-in of a display. When an input from a keyboard or a mouse is absent for a predetermined time period, the screen saver causes the display to display a moving image, thereby preventing burn-in of the display.

Jpn. Pat. Appln. KOKAI Publication No. 2002-351420 discloses a screen saver that displays an image composed mainly of a dark (black) display image component.

In recent years, the graphics function of a computer is improved, and there is known a screen saver that is designed for enjoyment of display images. In any case, the screen saver continues displaying an image on the display screen while maintaining a display luminance that is set prior to the activation of the screen saver. If a key input or a mouse operation is executed, the screen saver is instantaneously halted. The display screen is restored to the state prior to the activation of the screen saver. This makes it possible to quickly resume the suspended work. A secondary advantageous effect of the use of the screen saver is that the operative state (i.e. operation standby state) of the system can clearly be indicated to the user.

As has been described above, the use of the screen saver can prevent burn-in of the display and can realize a system with high usability. In prior-art information processing apparatuses, however, the image of the screen saver is displayed with a display luminance that is equal to a display luminance set prior to the activation of the screen saver. This leads to a problem with power consumption, in particular, in a battery drive mode.

### BRIEF SUMMARY OF THE INVENTION

According to an embodiment of the present invention, there is provided an information processing apparatus comprising: an input device; a display device; a detection unit configured to detect whether a system state of the information processing apparatus is an idle state or a non-idle state, by monitoring an operation state of the input device; and a control unit that decreases, when the detection unit detects the idle state, a display luminance of the display device and causes the display device to display a predetermined image, and that restores, when the detection unit detects the non-idle state, the display device to a display state immediately prior to the detection of the idle state.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the structure of an information processing apparatus according to an embodiment of the present invention;

FIG. 2 is a block diagram showing a software configuration of the information processing apparatus according to the embodiment of the present invention;

FIG. 3 is a flow chart illustrating a process procedure according to a first embodiment of the invention;

FIG. 4 is a flow chart illustrating a process procedure according to a second embodiment of the invention;

FIG. 5A and FIG. 5B are timing charts illustrating the operation timing of a display unit according to a power saving control under a predetermined condition in the second embodiment of the invention; and

FIG. 6A and FIG. 6B are timing charts illustrating the operation timing of the display unit according to a power saving control under a predetermined condition in the second embodiment of the invention.

### DETAILED DESCRIPTION OF THE INVENTION

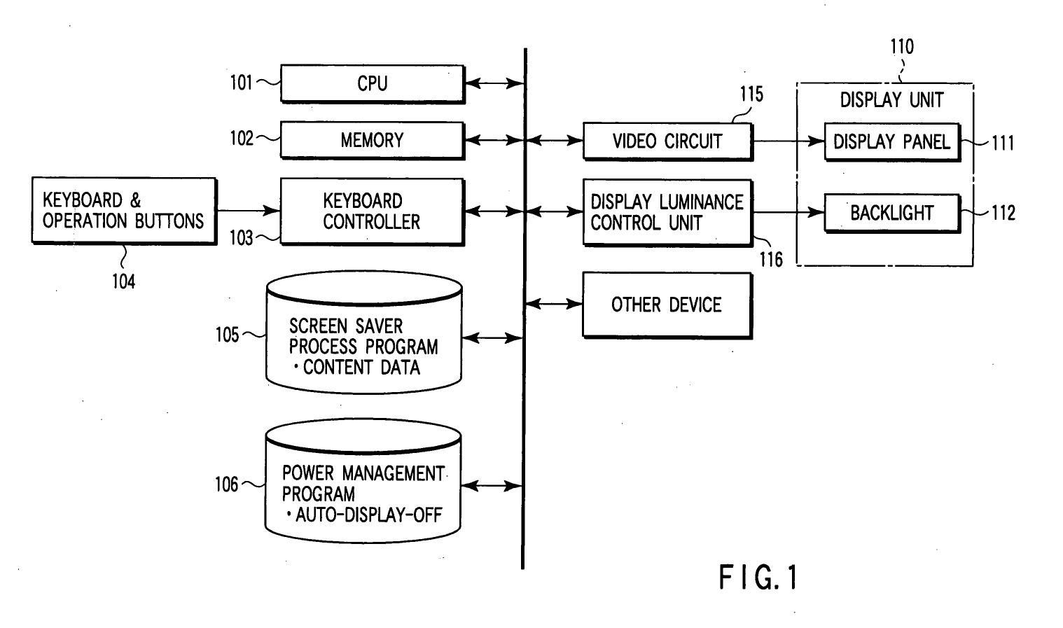

FIG. 1 shows the structure of an information processing apparatus according to an embodiment of the present invention. The system configuration of the information processing apparatus is described referring to a battery-powerable notebook personal computer by way of example.

The computer system, as shown in FIG. 1, includes a CPU 101, a memory (main memory) 102, a keyboard controller 103, an operation input device 104, program storage units 105 and 106, a video circuit 115, a display luminance control unit 116, and a display unit 110.

The display unit 110 includes a display panel 111, which comprises a transmission-type LCD (Liquid Crystal Display), and a backlight 112. The display luminance control unit 116 includes an inverter circuit that controls the illuminance of the backlight 112 provided in the display unit 110. The display luminance control unit 116 receives a display luminance control command (luminance value) from the CPU 101 and controls the illuminance of the backlight 112 in accordance with the display luminance control command, thereby controlling the display luminance of the display panel 111.

The video circuit 115 includes a video RAM. The video circuit 115 has a function of drawing a display image on the video RAM under the control of the CPU 101, and causing the display panel 111 of display unit 110 to display the display image. In this embodiment, the display panel 111 displays not only a display image, which is written in the video RAM by an operating system/application program, but also an image of a screen saver, which is written in the video RAM by a screen saver process program that is stored in the program storage unit 105.

The operation input device 104 comprises a keyboard, operation buttons, or a pointing device such as a mouse. The keyboard controller 103 has a function of informing the CPU 101 of an input command that is input in accordance with the operation of the operation input device 104. In this embodiment, the keyboard controller 103 monitors the operation of the operation input device 104 and detects that the system has transitioned to an idle state.

The program storage unit 105 stores a screen saver process program for executing a display control of the screen saver, content data of the screen saver, etc. In addition, the program storage unit 106 stores a power management program that realizes an idle detection function for detecting the idle state of the system, an auto-display-off function, etc.

The power management program that is stored in the program storage unit 106 includes a state monitoring program that realizes the system idle detection function, and a power saving control program that realizes the auto-display-off function, etc.

The state monitoring program has a process routine that monitors the operation state of the operation input device 104, determines whether the system is in an idle state or in a non-idle state, depending on the presence/absence of an operation input within a predetermined time period, and presents the determination result to a predetermined component.

The power saving control program has a power saving control routine (first embodiment) that decreases the illuminance of the backlight 112 of display unit 110 over a time period in the idle state, when the computer is set in a power saving mode; or a power saving control routine (second embodiment) that turns off the backlight 112 of display unit 110 over a time period in the idle state, when the computer is set in the power saving mode.

The screen saver process program that is stored in the program storage unit 105 has a process routine that activates and executes a screen saver according to preset screen saver content data, when the determination content of the state monitoring program has changed from the non-idle state to the idle state.

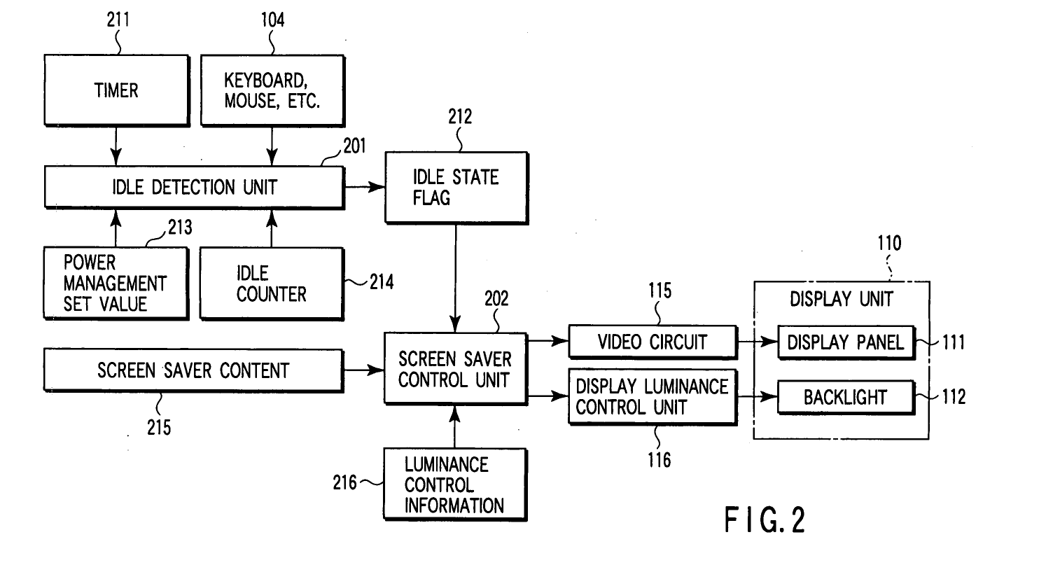

FIG. 2 shows the software configuration of the above-described computer system. The components common to those in FIG. 1 are denoted by like reference numerals.

In FIG. 2, an idle detection unit 201 is realized by the power management program that is stored in the program storage unit 106. A screen saver control unit 202 is realized by the screen saver process program that is stored in the program storage unit 105. A timer 211, an idle state flag 212 and an idle counter 214 are components that are used by the idle detection unit 201, and these components are realized using a counter, a register, etc. A power management set value 213 and luminance control information 216 are values that are preset on a prescribed setting screen, which is provided by a power management mechanism included in the system. The power management set value 213 is a set value that defines a wait time until activation of the screen saver. The luminance control information 216 is a set value that defines the display luminance of the display unit 110 at the idle time.

The idle detection unit 201 monitors the operation input state of the operation input device 104 at regular time intervals, using the timer 211. The idle detection unit 201 causes the idle counter 214 to measure a time period in which the operation input device 104 is in the non-operative state (i.e. the state in which no operation input is executed). If the value that is counted by the idle counter 214 reaches the preset power management set value 213, the idle detection unit 201 determines that the system has transitioned from the non-idle state to the idle state, and sets the idle state flag 212 (i.e. sets value “1”).

If the idle state flag 212 is set (i.e. value “1” is set), the screen saver control unit 202 activates the screen saver program according to preset screen saver content 215, and causes the display unit 110 to display an image of the screen saver with a display luminance corresponding to the luminance value of the luminance control information 216.

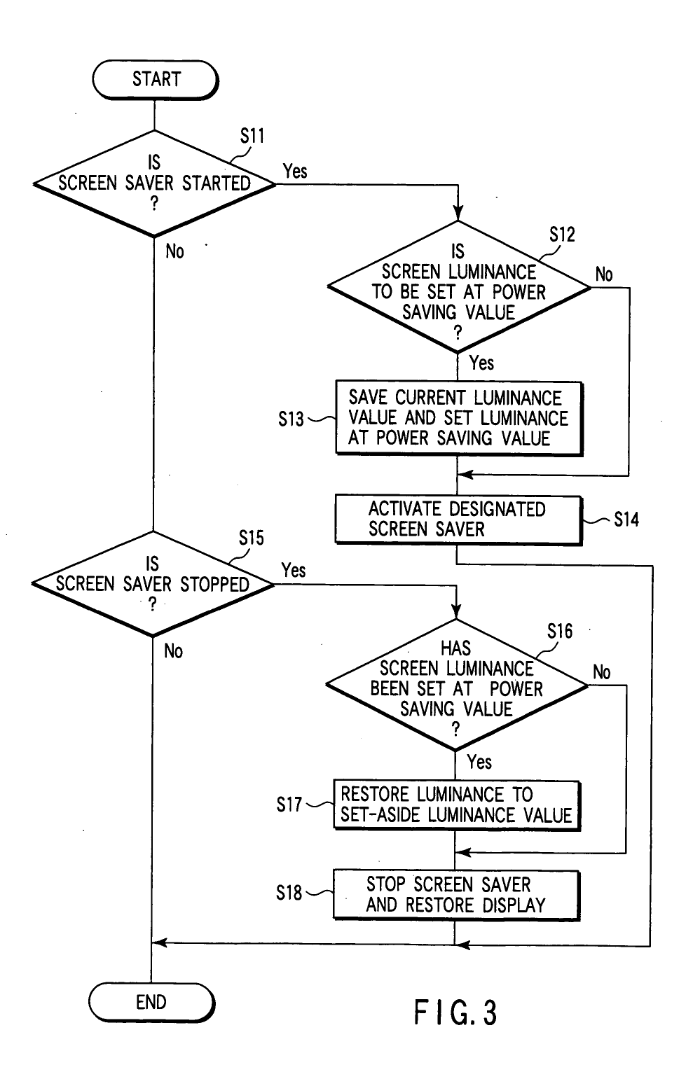

A flow chart of FIG. 3 illustrates a display control process procedure according to a first embodiment of the present invention. In this process of the first embodiment, when the screen saver is set and a power saving value (e.g. a minimum value of display luminance) is set as the luminance control information 216, the image of the screen saver is displayed with a display luminance corresponding to the power saving value at the idle time.

Referring to the flow chart of FIG. 3, the process operation in the first embodiment is described. The CPU 101 executes the following process, according to the power saving control routine included in the power management program that is stored in the program storage unit 106.

The CPU 101 monitors the operation input state of the operation input device 104 by means of the idle detection unit 201 that is realized by the power management program. The operation input state is monitored at regular time intervals, using the timer 211. The CPU 101 counts, by means of the idle counter 214, a time period in which an operation input through the operation input device 104 is absent. If a count value of the idle counter 214 reaches a preset power management set value 213, the CPU 101 determines that the system has transitioned from the non-idle state (working state) to the idle state, and sets the idle state flag 212 (i.e. set value “1”).

The CPU 101 refers to the idle state flag 212 by means of the screen saver control unit 202, and determines the start timing and the stop timing of the screen saver (steps S11 and S15 in FIG. 3). When the setting of the idle state flag 212 is detected (i.e. when a change from “0” to “1” is detected), the CPU 101 recognizes that the system has transitioned to the idle state (step S11 in FIG. 3). When resetting of the idle state flag 212 is detected (i.e. when a change from “11” to “0” is detected), the CPU 101 recognizes that the system has transitioned back to the non-idle state (step S15 in FIG. 3).

If the CPU 101 recognizes that the system has transitioned to the idle state (YES in step S11 in FIG. 3), the CPU 101 determines whether the luminance value of the luminance control information 216 is set at a power saving value (step S12 in FIG. 3). If the luminance control information 216 is set at a power saving value (YES in step S12 in FIG. 3), the current luminance value in the non-idle state is saved, and instead, the power saving value is set in the display luminance control unit 116 (step S13 in FIG. 3). Then, the screen saver according to the preset screen saver content is activated (step S14 in FIG. 3).

In this case, the display luminance control unit 116 controls the illuminance of the backlight 112, which is provided in the display unit 110, in accordance with the set power saving value, using an inverter circuit that controls the illuminance of the backlight 112. Thereby, the display luminance of the display panel 111 is decreased, and the display unit 110 is controlled in a power saving mode.

If the luminance value of the luminance control information 216 is not set at the power saving value (i.e. set at the normal luminance value) (NO in step S12 in FIG. 3), the CPU 101 activates the screen saver in the state in which the current luminance value in the non-idle state is maintained (step S14 in FIG. 3).

If the operation input device 104 is operated while the screen saver is being activated, the CPU 101 recognizes that the system has transitioned back to the non-idle state (YES in step S15 in FIG. 3). The CPU 101 determines whether the power saving value is set in the display luminance control unit 116 (i.e. whether the luminance value is saved when the screen saver is activated) (step S16 in FIG. 3). If the power saving value is set in the display luminance control unit 116 (YES in step S16 in FIG. 3), the CPU 101 substitutes the saved luminance value for the power saving value in the display luminance control unit 116, and restores the luminance value of the display unit 110 to the value in the previous non-idle state. Thus, the CPU 101 stops the screen saver and restores the display screen of the display unit 110 to the screen before the execution of the screen saver (steps S17 and S18 in FIG. 3). If the power saving value is not set in the display luminance control unit 116 (NO in step S16 in FIG. 3), the CPU 101 immediately stops the screen saver and the restores the display screen of the display unit 110 to the screen before the execution of the screen saver (step S18 in FIG. 3).

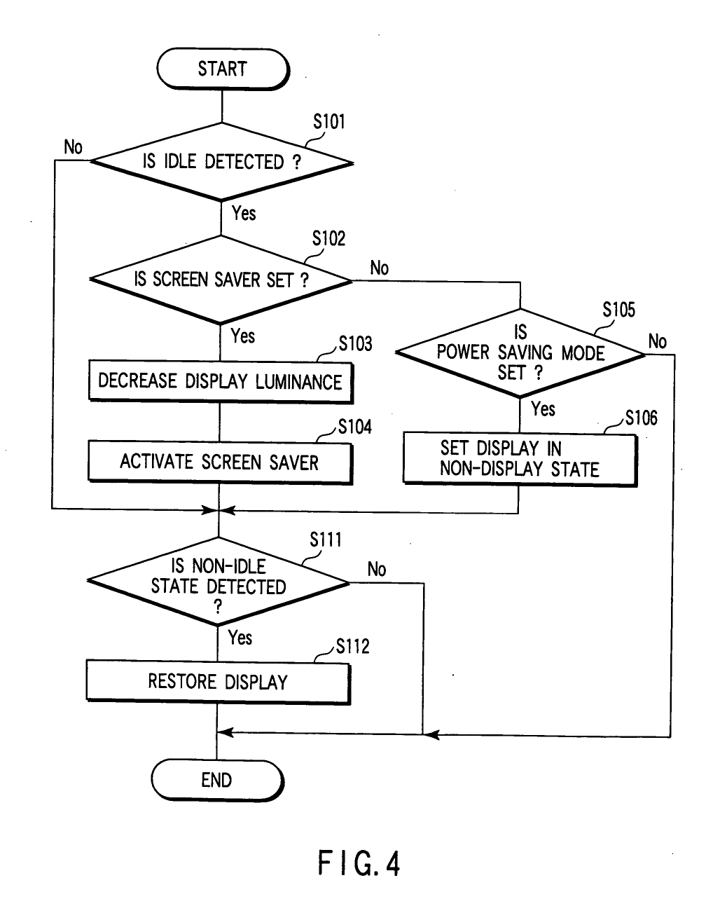

A flow chart of FIG. 4 illustrates a display control process according to a second embodiment of the present invention. In the process according to the second embodiment, when the screen saver is set, the image of the screen saver is displayed with a display luminance according to a power saving value at the idle time. On the other hand, when the screen saver is not set but the power saving mode is set, the backlight 112 of the display unit 110 is turned off at the idle time.

Referring to the flow chart of FIG. 4, the process operation in the second embodiment of the invention will now be described. A description of the control of the idle state flag 212 is omitted here, since it has already been described in connection with the first embodiment.

The CPU 101 refers to the idle state flag 212 by means of the screen saver control unit 202. If the CPU 101 recognizes that the system is in the idle state (YES in step S101 in FIG. 4), the CPU 101 determines whether the screen saver is set or not, that is, whether the screen saver is enabled or not, on the basis of the preset screen saver setting information (step S102 in FIG. 4). If the screen saver is set, that is, if the screen saver is enabled (YES in step S102 in FIG. 4), the CPU 101 decreases the display luminance of the display unit 110 and activates the screen saver (steps S103 and S104 in FIG. 4). A description of the control for decreasing the display luminance of display unit 110 in this case is omitted here, since it has already been described in connection with the first embodiment.

If the screen saver is not set, that is, if the screen saver is disabled (NO in step S102 in FIG. 4), the CPU 101 refers to the power management set value 213 and determines whether the power saving mode is set or not (step S105 in FIG. 4).

If the power saving mode is set (YES in step S105 in FIG. 4), the CPU 101 turns off the backlight 112 and switches off the display panel 111 in the display unit 110, thereby effecting the power saving control for halting the operation of the display unit 110 (step S106 in FIG. 4).

In addition, the CPU 101 refers to the idle state flag 212 by means of the screen saver control unit 202. If the CPU 101 recognizes that the system has transitioned back to the non-idle state (YES in step S111 in FIG. 4), the CPU 101 restores the display unit 110 to the display state immediately prior to the idle state (step S112 in FIG. 4).

As has been described above, in the second embodiment, when the screen saver is enabled, the image of the screen saver is displayed with a display luminance according to the power saving value at the idle time. On the other hand, in the case where the screen saver is disable, if the power saving mode is set, the power saving control is executed to stop the display operations of the display unit 110 including the operation of the backlight 112.

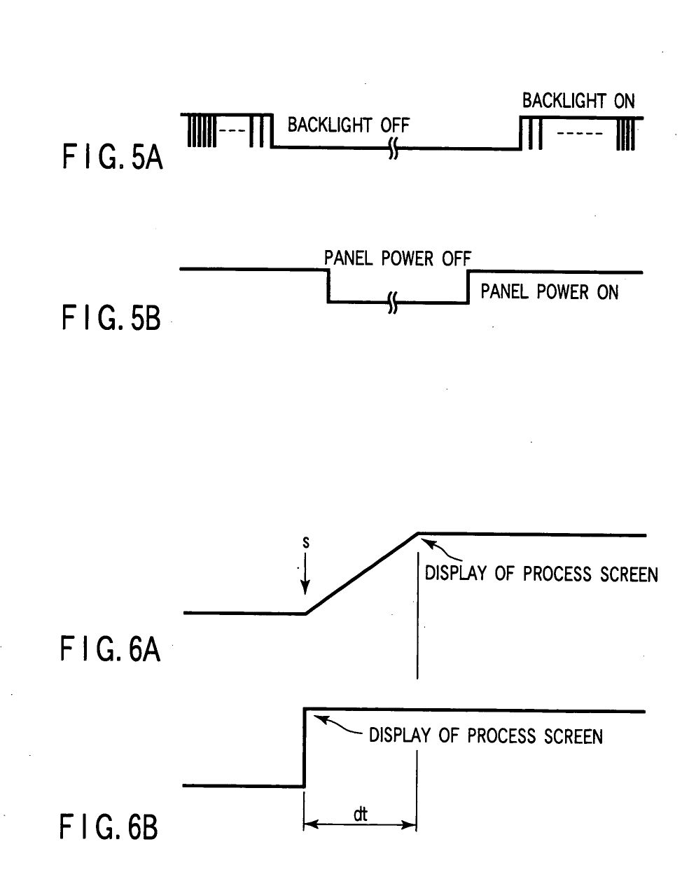

FIG. 5A and FIG. 5B show the operation timing of the display unit 110 in the power saving control (step S106 in FIG. 4) in the case where the screen saver is not set but the power saving mode is set. FIG. 5A illustrates the operation state of the backlight 112, and FIG. 5B the operation state of the display panel 111. As is shown in FIG. 5A, at a time when the operation of the display unit 110 is stopped, the intervals of pulses that are supplied to the inverter circuit of the display luminance control unit 116 are controlled to lower the luminance of the backlight 112. After the backlight 112 is turned off, the display panel 111 is powered off, as shown in FIG. 5B. At a time when the operation of the display unit 110 is started (i.e. resumption of display), the display panel 111 is first powered on, as shown in FIG. 5B. After the operation of the panel is stabilized, the intervals of pulses that are supplied to the inverter circuit are controlled, as shown in FIG. 5A, and the illuminance of the backlight 112 is restored to the level immediately prior to the turn-off of the backlight 112.

As described above, the backlight 112 is turned off, and the display panel 111 is powered off. Thereby, compared to the case where the image of the screen saver is displayed in the state in which the display luminance of the display unit 110 is lowered, the power consumption of the display unit 110 in the idle state can remarkably be reduced. However, when the system is restored to the non-idle state, a delay occurs in the restoration of the screen, as shown in FIG. 6A, compared to the case shown in FIG. 6B where the screen is restored by stopping the screen saver. Thus, there is some problem with the usability at the time of resuming the operation. In FIG. 6A and FIG. 6B, “s” indicates a switch timing from the idle state to the non-idle state, for example, a timing at which the operation input device 104 is activated in the idle state. In FIG. 6A and FIG. 6B, “dt” indicates a delay time in the restoration of the screen in the case where the display unit 110 is set in the power-off state.

In each of the above-described embodiments, as long as the system remains in the idle state, the screen saver is executed, under the predetermined condition, in the power saving mode in which the display luminance is decreased. However, some other display mode, aside from the screen saver mode, may be adopted if such a display mode permits the user to easily recognize, through the display screen of the display unit 110, that the system is in the idle state (or the system power is in the ON state). For example, as long as the system is in the idle state, the display luminance may be decreased, and a specified color, other than black, may be displayed on the entire display screen of the display unit 110. Alternatively, a screen image, which is prepared in advance in order to indicate that the system is in the idle state (or the system power is in the ON state), may be displayed. Thus, the user may be notified that the system is in the idle state (i.e. standby state for operation input).

As has been described above, in the embodiments of the invention, while the system is in the idle state, it is deemed that the display screen is in the non-used state in which the screen is not visually recognized. During this time period, the display luminance is decreased to reduce useless power consumption. Thereby, useless power consumption is reduced while the operational environment with high usability is maintained. This contributes to an extension of the operation time in the battery drive mode.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information processing apparatus comprising:
an input device;
a display unit;
a detection unit configured to detect whether a system state of the information processing apparatus is an idle state or a non-idle state, by monitoring an operation state of the input device; and
a control unit configured to decrease a display luminance of the display unit and cause the display unit to display a predetermined image when the detection unit detects the idle state, and configured to restore the display unit to a display state immediately prior to the detection of the idle state when the detection unit detects the non-idle state.

2. The information processing apparatus according to claim 1, wherein the control unit is configured to execute a screen saver function to display the predetermined image, when the detection unit detects that the system state is the idle state.

3. The information processing apparatus according to claim 1, further comprising means for enabling a screen saver function,
wherein the control unit includes a unit that determines whether the screen saver function is enabled when the detection unit detects the idle state, a first control unit that decreases the display luminance of the display unit and executes the screen saver function if the screen saver function is enabled, and a second control unit that sets the display unit in a non-display state if the screen saver function is not enabled.

4. The information processing apparatus according to claim 3, wherein the display unit includes a light source, and
the first control unit decreases luminance of the light source of the display unit, and the second control unit turns off the light source of the display unit.

5. A power saving control method for an information processing apparatus including an input device and a display unit, comprising:
monitoring an operation state of the input device to detect whether a system state of the information processing apparatus is an idle state or a non-idle state;
performing a display control process when it is detected that the system state transitions to the idle state, the display control process including a first process of decreasing a display luminance of the display unit, and a second process of causing the display unit to display a predetermined image; and
restoring the display unit to a display state immediately prior to the detection of the idle state, when it is detected that the system state transitions back to the non-idle state.

6. The power saving control method according to claim 5, wherein the second process includes executing a screen saver function to display the predetermined image.

7. The power saving control method according to claim 6, further comprising determining whether the screen saver function is enabled; and setting the display unit in a non-display state if the screen saver function is not enabled.

8. The power saving control method according to claim 5, wherein the display unit includes a light source, and
the first process includes a process of decreasing luminance of the light source of the display unit.

9. The power saving control method according to claim 7, wherein the display unit includes a light source, and
the setting the display unit in the non-display state includes turning off the light source of the display unit.

10. An information processing apparatus comprising:
an input device;
a display unit;
means for monitoring an operation state of the input device to detect whether a system state of the information processing apparatus is an idle state or a non-idle state;
means for performing a display control process when it is detected that the system state transitions to the idle state, the display control process including a first process of decreasing a display luminance of the display unit and a second process of causing the display unit to display a predetermined image; and
means for restoring the display unit to a display state immediately prior to the detection of the idle state, when it is detected that the system state transitions back to the non-idle state.

11. The information processing apparatus according to claim 10, wherein the first process includes executing a screen saver function to display the predetermined image.

12. The information processing apparatus according to claim 11, further comprising means for determining whether the screen saver function is enabled; and means for setting the display unit in a non-display state if the screen saver function is not enabled.

13. The information processing apparatus according to claim 10, wherein the display unit includes a light source, and
the first process includes a process of decreasing luminance of the light source of the display unit.

14. The information processing apparatus according to claim 12, wherein the display unit includes a light source, and
the means for setting the display unit in the non-display state includes means for turning off the light source of the display unit.
